(19) United States
(12) Patent Application Publication
(10) Pub. No.: US 2006/0209238 A1
(43) Pub. Date: Sep. 21, 2006

(54) Cholesteric liquid crystalline film, method for production thereof and circularly polarized light reflecting film, two wavelength region reflection type reflecting film

(76) Inventors: Miki Shiraogawa, Osaka (JP); Kazutaka Hara, Osaka (JP); Takahiro Fukuoka, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/555,377

(22) PCT Filed: Apr. 15, 2004
(86) PCT No.: PCT/JP04/05360

§ 371 Date: Nov. 2, 2005

(30) Foreign Application Priority Data
May 2, 2003 (JP) 2003-126998

(51) Int. Cl. G02F 1/1335

(52) U.S. Cl. 349/115

(57) ABSTRACT

A cholesteric liquid crystal film of the invention consist of a single layer, which is a cholesteric liquid crystal film, formed by applying a liquid crystal mixture containing a polymerizable mesogen compound (A) and a polymerizable chiral agent (B) to an alignment substrate, and applying ultraviolet irradiation to the mixture, wherein a cholesteric liquid crystal film has at least two independent selective reflection wavelength bands. The cholesteric liquid crystal film can be prepared by a simple and easy procedure.

### TECHNICAL FIELD

The invention relates to a cholesteric liquid crystal film and a method of producing the same. The cholesteric liquid crystal film of the invention has at least two independent selective reflection wavelength bands and is useful as a circularly-polarized-light-reflecting plate (a circular polarization type reflective polarizer). A laminate of the circularly-polarized-light-reflecting plates can be used as a reflecting film for specifically reflecting light in two specific wavelength ranges. For example, if the two specific wavelength ranges exist in an ultraviolet wavelength range and an infrared wavelength range, respectively, it will be useful as a film for eye protection. Such a film is preferably used for eyeglasses such as sunglasses and protective glasses for laser working, window-glasses of vehicles such as automobiles, and windowpanes of buildings. If the two specific wavelength ranges exist in the visible wavelength range, it will preferably be used as a complementary color filter or the like for liquid crystal displays.

### BACKGROUND ART

A cholesteric liquid crystal having a circularly polarized light separating function has a selective reflection characteristic reflecting only circularly polarized light having a direction thereof coinciding with a helical rotation direction of the liquid crystal and a wavelength equal to a helical pitch length of the liquid crystal. With this selective reflection characteristic used, only a specific circularly polarizing light of natural light in a given wavelength band is transmission-separated and the other light components are reflected and recycled, thereby enabling a circularly-polarized-light-reflecting film with a high efficiency to be manufactured.

Two types of circularly-polarized-light-reflecting films that are substantially the same in selective reflection wavelength band and opposite in the rotation direction of the cholesteric spiral may be laminated so as to function as a reflecting film. Two types of circularly-polarized-light-reflecting films that are substantially the same in selective reflection wavelength band and same in the helical rotation direction of the cholesteric spiral may also be laminated with a half-wave plate (λ/2 plate) sandwiched therebetween to form a similar reflecting film.

There has been, usually, difficulty in covering all the range of visible light, since a selective reflection characteristic of a cholesteric liquid crystal is restricted to only a specific wavelength band. A selective reflection wavelength bandwidth. Δλ is expressed by following formula:
Δλ=2λ·(nₑ−nₒ)/(nₑ+nₒ)

where nₒ: ordinary light refractive index of a cholesteric liquid crystal molecule, nₑ: extraordinary light refractive index of the cholesteric liquid crystal molecule, and λ: central wavelength in selective reflection.

The selective reflection wavelength bandwidth Δλ depends on a molecular structure of the cholesteric liquid crystal itself. According to the above formula, if (nₑ−nₒ) is larger, a selective reflection wavelength bandwidth Δλ can be broader, while (nₑ−nₒ) is usually 0.3 or less. With this value being larger, other functions as a liquid crystal (such as alignment characteristic, a liquid crystal temperature or the like) becomes insufficient, causing its practical use to be difficult. Therefore, a selective reflection wavelength bandwidth a has been actually about 150 nm at highest. A cholesteric liquid crystal available in practical aspect has had a selective reflection wavelength bandwidth Δλ only in the range of about 30 to 100 nm in many cases.

A selective reflection central wavelength λ is given by the following formula:
λ=(nₑ+nₒ)P/2

where P: helical pitch length required for one helical turn of cholesteric liquid crystal.

With a given pitch length, a selective reflection central wavelength λ depends on an average refractive index and a pitch length of a liquid crystal molecule.

Conventionally, therefore, different cholesteric liquid crystal layers having different central wavelengths for selective reflection are laminated for the purpose of freely controlling the reflection/transmission properties for any different reflection wavelength bands.

For the purpose of cutting off ultraviolet and infrared rays harmful to the eyes in the outdoors, for example, spectacles should have protection filters capable of selectively reflecting light in an ultraviolet wavelength range and an infrared wavelength range. Such protection filters for spectacles need a laminate of different cholesteric liquid crystal films having at least two central wavelengths for selective reflection in an ultraviolet wavelength range and an infrared wavelength range. As mentioned above, the reflecting-film function requires at least another pair of the same cholesteric liquid crystal films. Thus, the protection filter for spectacles as mentioned above needs at least four layers of the cholesteric liquid crystal or at least five layers including the cholesteric liquid crystal layers and a half-wave plate sandwiched therebetween.

A variety of methods are proposed in which a cholesteric liquid crystal polymer is used to form a cholesteric liquid crystal layer (a selective reflection layer) with a modified band. However, all of such conventional methods are for broadening the band of the selective reflection layer and cannot produce a single cholesteric liquid crystal layer having at least two independent selective reflection wavelength bands.

For example, a method is proposed in which the band of a cholesteric liquid crystal layer is broadened using inhibition by oxygen (Japanese Patent Application Laid-Open No. 2002-286935). A method is also proposed which includes performing two-stage exposure to light and annealing in a dark place to promote the mass transfer (European Patent Publication No. 0885945). In all the methods disclosed in these patent applications, however, the selective reflection wavelength band of the cholesteric liquid-crystal is only broadened after a reaction, and no phenomenon of peak division is caused for the selective reflection wavelength, and thus independent selective reflection wavelength bands are not produced.

For example, a certain cholesteric liquid crystal layer has two peaks at selective reflection wavelengths before broadband-forming treatment is performed (U.S. Pat. No. 6,417,902). However, this patent literature relates to a process of multilayer coating of liquid crystal layers having different components for combination of peaks. This process needs the production of a plurality of liquid crystal layers and is complicated.

Also proposed is a liquid crystal layer having cholesteric pitches nonlinearly varying in the thickness direction and a method of producing the same (the brochure of International Publication No. 98/20090). In this patent document, however, the nonlinear variation in pitch is continuous and does not produce at least two independent selective reflection wavelength bands.

The conventional known methods for producing at least two selective reflection wavelength bands only include methods of applying and stacking at least two types of cholesteric liquid crystal layers, methods of laminating at least two types of cholesteric liquid crystal layers, and methods of forming a mixture-containing film by pulverizing at least two types of liquid crystal thin films and mixing them. All of the conventional methods need at least two cholesteric-liquid-crystal-layer-forming steps.

Interference filters formed by vapor-deposition of inorganic materials are known as optical materials (polarized-light-reflecting films) similar to the cholesteric liquid crystal layer. However, the equipment for manufacturing the interference filters by vacuum deposition method is expensive, and more than a dozen to twenty layers should be laminated to form an interference filter. Therefore, the cost of the interference filter must be high. Similarly known is a stretched laminate of resin thin films having different refractive indices, such as DBEF, ESR and GBO multilayer films manufactured by 3M. Laminating many layers and precision stretching are also necessary for the production of these films.

### DISCLOSURE OF INVENTION

It is an object of the invention to provide a cholesteric liquid crystal film that can be easily produced and has at least two independent selective reflection wavelength bands and to provide a method of producing the same.

It is another object of the invention to provide a circularly-polarized-light-reflecting plate using the cholesteric liquid crystal film, a reflecting film using the circularly-polarized-light-reflecting film, and a variety of optical products using the reflecting film.

In order to solve the above problems, the inventors have made active investigations and finally found that the cholesteric liquid crystal film and the method of producing the same as described below can achieve the above objects, in completing the invention. Thus, the invention is as follows:

1. A cholesteric liquid crystal film; consisting of a single layer, which is a cholesteric liquid crystal film, formed by applying a liquid crystal mixture containing a polymerizable mesogen compound (A) and a polymerizable chiral agent (B) to an alignment substrate, and applying ultraviolet irradiation to the mixture, wherein
the cholesteric liquid crystal film has at least two independent selective reflection wavelength bands.

2. The cholesteric liquid crystal film according to the above-mentioned 1, wherein the independent selective reflection wavelength bands have central wavelengths for selective reflection in an ultraviolet wavelength range and an infrared wavelength range, respectively.

3. The cholesteric liquid crystal film according to the above-mentioned 1 or 2, wherein a reaction rate of the polymerizable mesogen compound (A) and the polymerizable chiral agent (B) is different, respectively.

4. The cholesteric liquid crystal film according to any one of the above-mentioned 1 to 3, wherein the number of polymerizable functional groups in the polymerizable chiral agent (B) is larger than those in the polymerizable mesogen compound (A).

5. A method of producing the cholesteric liquid crystal film according to any one of the above-mentioned 1 to 4, comprising the steps of:
applying a liquid crystal mixture containing (A) a polymerizable mesogen compound and (B) a polymerizable chiral agent to an alignment substrate; and
applying ultraviolet irradiation to the liquid crystal mixture from the alignment substrate side in such a state that the mixture is in contact with an oxygen-containing gas to polymerize and cure the mixture.

6. The method according to the above-mentioned 5, wherein the step of applying ultraviolet irradiation to polymerize and cure the mixture is performed at a temperature of 20° C. or more.

7. The method according to the above-mentioned 5, wherein, an ultraviolet irradiation temperature at a later stage in the step of applying ultraviolet irradiation to polymerize and cure is controlled higher than that at an earlier stage.

8. A two-wavelength-range reflection type circularly-polarized-light-reflecting film, comprising the cholesteric liquid crystal film according to any one of the above-mentioned 1 to 4.

9. A reflecting film capable of covering two wavelength ranges, comprising:
a laminate of two pieces of the circularly-polarized-light-reflecting film according to the above-mentioned 8, wherein the two pieces of the circularly-polarized-light-reflecting film have substantially the same selective reflection wavelength bands and are opposite in cholesteric twist direction.

10. A reflecting film capable of covering two wavelength-ranges, comprising:
a laminate of a half-wave plate sandwiched between two pieces of the circularly-polarized-light-reflecting film according to the above-mentioned 8, wherein the two pieces of the circularly-polarized-light-reflecting film have substantially the same selective reflection wavelength bands and are same in cholesteric twist direction.

11. The reflecting film according to the above-mentioned 10, the half-wave plate is a broadband half-wave plate comprising a laminate of at least two different retardation plates.

12. An eye protecting film, comprising the reflecting film capable of covering two wavelength-ranges according to any one of the above-mentioned 9 to 11.

13. An eye protecting plate, comprising:
a transparent supporting substrate; and
the eye protecting film according to the above-mentioned 12 which is bonded to the substrate.

14. A transparent viewing member, comprising the eye protecting film according to the above-mentioned 12 or the eye protecting plate according to the above-mentioned 13.

15. A complementary color filter, comprising the reflecting film according to any one of the above-mentioned 8 to 11.

16. A liquid crystal display, comprising the complementary color filter according to the above-mentioned 15.

(Functions and Effects)

The cholesteric liquid crystal film of the invention is a single layer film having at least two independent selective reflection wavelength bands. The independent selective reflection wavelength bands can be selected depending on the purpose of use. The independent selective reflection wavelength bands each preferably have a width of about 20 to about 200 nm. The width of each selective reflection wavelength band may be measured by the method as shown in Examples.

For example, the cholesteric liquid crystal film is produced by a process including the steps of applying, to an alignment substrate, a liquid crystal mixture containing (A) a polymerizable mesogen compound and (B) a polymerizable chiral agent; and applying ultraviolet irradiation from the alignment substrate side in the presence of oxygen for inhibiting polymerization. Thus, the cholesteric liquid-crystal film having any two or more selective reflection wavelength bands can be obtained with a reduced number of layers, a reduced number of processes and a reduced cost, as compared with the conventional methods.

The method of producing the cholesteric liquid crystal film according to the invention uses the difference in the rate of polymerization between the uncovered face of the cholesteric liquid crystal and the substrate-covered face of it, which is caused by oxygen-induced inhibition as described in Japanese Patent Application No. 2001-339632. In this method, the exposure to light is performed in the direction from the substrate face side to the liquid crystal so that the difference in the rate of polymerization can be significantly increased and that the composition ratio of the cholesteric liquid crystal mixture can vary in the thickness direction. Therefore, this method is further developed from a method of making a difference in the pitch length of a cholesteric liquid crystal layer between the uncovered face of the cholesteric liquid crystal and both sides of a substrate.

In the invention, cholesteric liquid crystal materials different in reaction rate are used and heated under the polymerization conditions for band broadening as described in Japanese Patent Application No. 2001-339632 so that the difference in mass-transfer speed between the liquid crystal materials allows the production of at least two extremely-separated discontinuous pitch lengths in the cholesteric liquid crystal layer.

According to the basic mechanism, the selective reflection wavelength band of the cholesteric liquid crystal produced by the initial polymerization is set at a value determined by the liquid crystal composition before the polymerization, while the polymerization and heating promote the mass transfer of the liquid crystal composition so that another independent selective reflection wavelength band is generated in a different wavelength range.

A mixture of a polymerizable mesogen compound (A) and a polymerizable chiral agent (B) is used as the cholesteric liquid crystal material. When the reactivity and reaction rate of the polymerizable mesogen compound (A) are lower than those of the polymerizable chiral agent (B), the polymerization is started so as to produce a selective reflection wavelength determined by the initial blend ratio, but the rate of consumption of the polymerizable chiral agent (B) is higher so that the polymerizable mesogen compound (A) can be left as the polymerization proceeds and that the monomer ratio of the remaining composition can be different from the initial ratio. In this process, the monomer transfer speed may be controlled by the control of the heating temperature so that the blend ratio of the polymerizable mesogen compound (A) to the polymerizable chiral agent (B) can be controlled during the later stage of the polymerization. In this case, the most part of the polymerizable chiral agent (B) is consumed by a certain time in the latter part of the polymerization, and under such conditions, namely under the polymerizable mesogen compound (A) rich conditions, the polymerization is completed, so that the layer cured in the latter part of the polymerization can have a weak twist and have a selective reflection wavelength band at a position significantly shifted to the long wavelength side. Thus, the single layer coating of the liquid crystal mixture containing the polymerizable mesogen compound (A) and the polymerizable chiral agent (B) and the single ultraviolet irradiation to the mixture allow the production of regions having different pitches in the direction of the thickness of the formed cholesteric liquid crystal layer so that the cholesteric liquid crystal film having at least two selective reflection wavelength bands can be produced.

In the liquid crystal temperature environment, the environmental temperature for the ultraviolet irradiation may be increased for the purpose of increasing the mass-transfer speed so that the single layer coating can form a similar cholesteric liquid crystal film having at least two selective reflection wavelength bands. In this case, the intensity of the ultraviolet irradiation may also be controlled, while the environmental temperature is increased during the ultraviolet irradiation.

The relationship between the reaction rates of the polymerizable mesogen compound (A) and the polymerizable chiral agent (B) may be varied so that the formed film structure can be opposite to the above or the space of the selective reflection wavelength bands or the size of the peak at each central wavelength for selective reflection can be controlled.

### BRIEF DESCRIPTION OF DRAWINGS

FIG. 1 is a reflectance spectrum of a cholesteric liquid crystal film manufactured in Example 1.

FIG. 2 is a reflectance spectrum of a cholesteric liquid crystal film manufactured in Example 2.

### BEST MODE FOR CARRYING OUT THE INVENTION

A cholesteric liquid crystal film of the present invention is obtained by ultraviolet polymerizing a liquid crystal mixture containing a polymerizable mesogen compound (A) and a polymerizable chiral agent (B).

The polymerizable mesogen compound (A) and the polymerizable chiral agent (B) for use preferably have different reaction rates. Typically, the more the number of the polymerizable functional groups, the higher the reaction rate. In order to prepare the liquid crystal mixture in which the reaction rate of the polymerizable mesogen compound (A) is lower than that of the polymerizable chiral agent (B), therefore, the number of the polymerizable functional groups of the polymerizable chiral agent (B) may be larger than those of the polymerizable mesogen compound (A) in the combination.

A polymerizable mesogen compound (A) preferably has at least one polymerizable functional group and in addition, a mesogen group containing a ring unit and others. As polymerizable functional groups, exemplified are an acryloyl group, a methacryloyl group, an epoxy group, a vinyl ether group and others, among which preferable are an acryloyl group and a methacryloyl group. Using a compound having at least two polymerizable functional groups, a crosslinked structure can also be introduced to increase the durability. Examples of the cyclic unit for the mesogen group include a biphenyl unit, a phenylbenzoate unit, a phenylcyclohexane unit, an azoxybenzene unit, an azomethine unit, an azobenzene unit, a phenylpyrimidine unit, a diphenylacetylene unit, a diphenylbenzoate unit, a bicyclohexane unit, a cyclohexylbenzene unit, and a terphenyl unit. The terminal of each of these cyclic units may have a substituent such as cyano group, alkyl group, alkoxyl group, and halogen group. The mesogen group may be bonded via a spacer moiety for imparting flexibility. Examples of the spacer moiety include a polymethylene chain and a polyoxymethylene chain. The number of the repeating structural units forming the spacer moiety is properly determined depending on the chemical structure of the mesogen moiety. For example, the number of the repeating units in a polymethylene chain is from 0 to 20, preferably from 2 to 12, and the number of those in a polyoxymethylene chain is from 0 to 10, preferably from 1 to 3.

As a polymerizable mesogen compound (A) having at least one polymerizable functional group, as described above, is a compound represented by the following general formula (1): 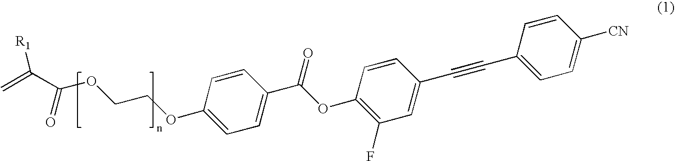
wherein R₁ represents a hydrogen atom or a methyl group, and n is an integer of 1 to 5.

As concrete examples of the polymerizable mesogen compound (A) having at least one polymerizable functional group, exemplified are the compounds represented by following polymerizable mesogen compound (1) to (4):

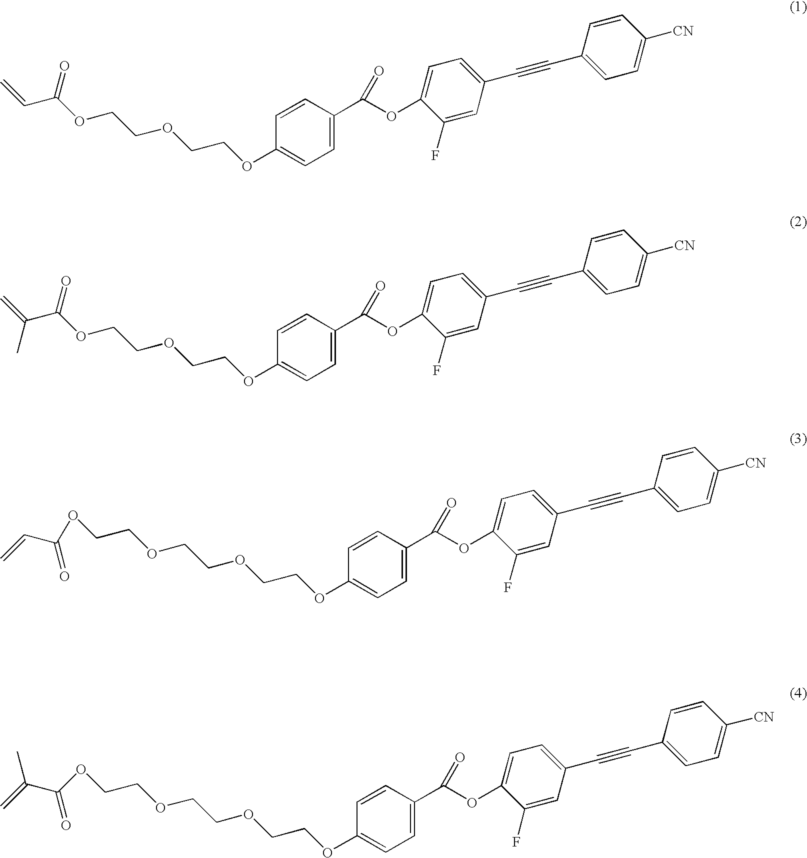

For example, a compound having at least one polymerizable functional group and an optically-active group is preferably used as the polymerizable chiral agent (B). The polymerizable functional group may be any of the above functional groups. If the polymerizable mesogen compound (A) has one polymerizable functional group, the polymerizable chiral agent (B) should preferably have two or more polymerizable functional groups.

For example, the polymerizable chiral agent (B) having at least two polymerizable functional groups may be the compound represented by the general formula (2): 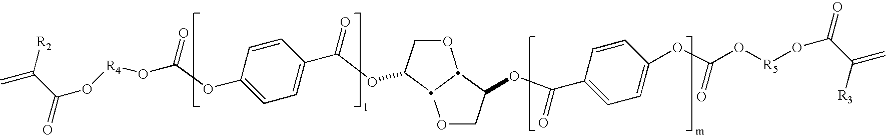
wherein R₂ and R₃ each represent a hydrogen atom or methyl group, R₄ and R₅ each represent an optionally substituted alkylene of 1 to 12 carbon atoms, and 1 and m each independently represent an integer of 1 to 3.

As a polymerizable chiral agent (B), exemplified is LC756 manufactured by BASF Ltd.

A mixing amount of a polymerizable chiral agent (B) is preferably in the range of about from to 20 parts by weight and more preferably in the range of from 3 to 7 parts by weight relative to 100 parts by weight of a total amount of a polymerizable mesogen compound (A) and the polymerizable chiral agent (B). A helical twist power (HTP) is controlled by a ratio of a polymerizable mesogen compound (A) and a polymerizable chiral agent (B). By adjusting the proportion within the range, a reflection band can be selected so that a reflectance spectrum of an obtained cholesteric liquid crystal film can cover all the range of visible light.

The liquid crystal mixture usually contains photopolymerization initiators (C). Any kind of photopolymerization initiators (c), can be employed without imposing any specific limitation thereon. Exemplified are IRGACURE-184, IRGACURE 907, IRGACURE 369, IRGACURE 651, IRGACURE 748, IRGACURE 814, Darocure 1173, Darocure 4205 and others manufactured by Ciba Specialty Chemicals Inc. And LucirinTPO manufactured by BASF LTD. is preferably used. A mixing amount of a photopolymerization initiator is preferably in the range of about from 0.01 to 10 parts by weight and more preferably in the range of from 0.05 to 5 parts by weight relative to 100 parts by weight of a total amount of a polymerizable mesogen compound (A) and a polymerizable chiral agent (B). Although the necessary amount of the photopolymerization initiator tends to increase under air atmosphere, the desired object can be achieved using Irgacure 369 or Irgacure 907 in an amount of about 3 to about 5 parts by weight.

The liquid crystal mixture may contain an additive such as a surfactant for smoothing the surface to be coated the amount of the surfactant or the like may be set depending on the coating ability of liquid crystal mixture and is generally at most about 0.1 part by weight, preferably from about 0.01 to about 0.1 part by weight, based on 100 parts by weight of the total amount of the polymerizable mesogen compound (A) and the polymerizable chiral agent (B). For example, Fluorad 171 manufactured by 3M LTD., Zonyl Fsn manufactured by DuPont LTD., or BYK 361 manufactured by Bigchemi Japan Company LTD. is preferably used as the additive. Any of these additives may be properly selected depending on the type of the liquid crystal mixture, the blend properties or the like.

The mixture may contain an ultraviolet absorbing agent for broadening the band width of the resulting cholesteric liquid crystal film so that variations in the intensity of exposure to ultraviolet irradiation can be greater in the thickness direction. The same effect can be produced using a photopolymerization initiator having a large molar absorption coefficient.

The mixture may be used in the form of a solution. Examples of the solvent for use in the preparation of the solution generally include halogenated hydrocarbons such as chloroform, dichloromethane, dichloroethane, tetrachloroethane, trichloroethylene, tetrachloroethylene, and chlorobenzene; phenols such as phenol and para-chlorophenol; aromatic hydrocarbons such as benzene, toluene, xylene, methoxybenzene, and 1,2-dimethoxybenzene; and other solvents such as acetone, methyl ethyl ketone, ethyl acetate, tert-butyl alcohol, glycerol, ethylene glycol, triethylene glycol, ethylene glycol monomethylether, diethylene glycol dimethyl ether, ethylcellosolve, butylcellosolve, 2-pyrrolidone, N-methyl-2-pyrrolidone, pyridine, triethylamine, tetrahydrofuran, dimethylformamide, dimethylacetamide, dimethyl sulfoxide, acetonitrile, butyronitrile, carbon disulfide, cyclopentanone, and cyclohexanone. Preferred solvents for use herein include, but are not limited to, methyl ethyl ketone, cyclohexanone and cyclopentanone. The concentration of the solution depends on the solubility of the thermotropic liquid crystal compound and the thickness of the cholesteric liquid crystal film to be finally produced and thus cannot be uniquely defined but is generally preferably from about 3 to about 50% by weight.

According to the invention, the method of producing the broadband cholesteric liquid crystal film includes the steps of applying the liquid crystal mixture to an alignment substrate and applying-ultraviolet irradiation to the liquid crystal mixture to polymerize and cure the mixture.

As alignment substrates, there can be adopted conventionally known members as ones. Exemplified are: a rubbing film obtained by subjecting a thin film made of polyimide, polyvinyl alcohol or thelike formed on a substrate to a rubbing treatment with rayon cloth; an obliquely deposition film; optically oriented film obtained by illuminating a polymer having photocrosslinking group such as cynnamate, azobenzene or the like or a polyimide with polarized ultra-violet; and a stretched film and others. Orientation can be implemented by application of a magnetic field, an electric field and a shearing stress.

The substrate may be of any type but is preferably made of a material having a high transmittance because the radiation (ultraviolet light) is irradiated from the substrate side in the method. For example, the substrate should have a transmittance of at least 10%, preferably of at least 20%, in the ultraviolet range from 200 nm to 400 nm, preferably in the ultraviolet range from 300 nm to 400 nm. More specifically, the substrate is preferably a plastic film with a transmittance of at least 10%, more preferably of at least 20%, for ultraviolet irradiation with a wavelength of 365 nm. The transmittance may be a value measured by means of U-4100 Spectrophotometer manufactured by Hitachi Ltd.

The substrate may comprise a plastic film, glass or a quartz sheet. Examples of the plastic for the film include polyethylene terephthalate, polyethylene naphthalate (PEN), polyvinyl alcohol (PVA), polycarbonate (PC), triacetylcellulose (TAC), polyimide, polyarylate, polycarbonate, polysulfone, and polyethersulfone. Specific examples thereof include Melinex (PET) manufactured by ICI. Corporation, Lumirror (PET) manufactured by Toray Industries, Inc., Diafoil (PET) manufactured by Mitsubishi Polyester Film Corp., and Mylar (PET) manufactured by Teijin DuPont Films Limited.

The substrate may be used with the cholesteric liquid crystal layer attached thereto or may be separated and removed from the cholesteric liquid crystal layer. The substrate for use with the liquid crystal attached thereto preferably comprises a material whose retardation value is sufficiently small for practical use. Preferred examples for use in such a case include triacetylcellulose films manufactured by Fuji Photo Film Co., Ltd. (T-TAC, TD-TAC and UZ-TAC), ARTON manufactured by JSR Corporation, Zeonex and Zeonea films manufactured by Nippon Zeon Co., Ltd., and unstretched PC films. Examples thereof also include polymer films as disclosed in Japanese Patent Application Laid-Open No. 2001-343529 (WO01/37007) and a resin composition that contains (A) a thermoplastic resin having a side chain of a substituted and/or unsubstituted imide group and (B) a thermoplastic resin having a side chain of substituted and/or unsubstituted phenyl and nitrile groups. Specific examples include a film of a resin composition containing an alternating copolymer of isobutylene and N-methylmaleimide and an acrylonitrile-styrene copolymer. The film may be produced by mixing and extruding the resin composition.

The substrate for use with the liquid crystal attached thereto preferably comprises a material that is not decomposed, degraded or yellowed when exposed to ultraviolet irradiation. For example, the substrate may contain a light stabilizer so that the desired object can be achieved. The light stabilizer is preferably Tinuvin 120 or 144 manufactured by Ciba Specialty Chemicals Inc. Cutting off wavelengths not longer than 300 nm from the light for exposure allows a reduction in discoloration, degradation or yellowing.

The coating thickness of the liquid crystal mixture (the coating thickness after the solvent is dried off in the case that the mixture is a solution) is preferably from about 2 to about 20 μm. A coating thickness of less than 1 μm is not preferred, because such a thickness can keep a certain reflection band width but tend to allow the degree of polarization itself to be degraded. The coating thickness is preferably atleast 2 μm, more preferably at least 3 μm. A coating thickness of more than 20 μm is not preferred, because such a thickness cannot provide a significant improvement in any of reflection band width and degree of polarization and can simply increase the cost. The coating thickness is preferably at most 15 μm, more preferably at most 10 μm, still more preferably at most 7 μm. The coating thickness of the liquid crystal mixture is from 2 to 10 μm, preferably from 3 to 7 μm, in a case where color properties are important for the coverage of the entire visible light range.

In the process of forming an infrared ray-reflecting film having selective reflection properties beyond the visible light range, the coating thickness may be 10 μm or more such that necessary reflection properties can be sufficiently obtained up to the long-wavelength end of an infrared range. This is because concerning the selective reflection of the cholesteric liquid crystal, there is a direct proportionality between the selective reflection wavelength and the helical pitch as shown by the above formula so that the pitch length should be increased as the wavelength becomes longer. The thickness should be as large as several pitches in order to provide a sufficient selective reflectivity.

For example, roll coating, gravure coating, spin coating, bar coating, or the like may be used in the process of applying the mixture solution to the alignment substrate. After the mixture solution is applied, the solvent is removed so that a liquid crystal layer can be formed on the substrate. The removal of the solvent may be performed under any conditions, as long as the solvent can be almost removed without flowing or flowing down of the liquid crystal-layer. The solvent is usually removed by drying at room temperature, drying in a drying oven, heating on a hot plate, or the like.

Thereafter, the liquid crystal layer formed on the alignment substrate is heated to the isotropic transition temperature or higher to form a liquid crystal state of cholesteric orientation and then gradually cooled so that a uniform orientation state can be maintained. In the alignment process, the liquid crystal mixture is aligned in such a manner that the axis of the cholesteric spiral is aligned perpendicular to the surface of the alignment substrate.

For the alignment, the liquid crystal layer is heat-treated in the liquid crystal temperature range. The heat treatment method may be the same as the above drying method. The heat treatment temperature varies with the type of the liquid crystal material or the alignment substrate and cannot be uniquely defined, while it is generally from 60 to 300° C., preferably from 70 to 200° C. The heat treatment time varies with the heat treatment temperature and the type of the liquid crystal material or the alignment substrate used and cannot be uniquely defined, while it is generally selected from the range from 10 seconds to 2 hours, preferably from 20 seconds to 30 minutes.

While the liquid crystal mixture maintains the aligned liquid crystal state, ultraviolet irradiation is applied from the alignment substrate side to polymerize and cure the liquid crystal mixture. Ultraviolet irradiation is applied to the liquid crystal mixture in such a state that the mixture is in contact with an oxygen-containing gas. Ultraviolet irradiation is applied from the alignment substrate side so that inhibition of polymerization by oxygen can be positively used. Thus, the polymerization is initiated from the alignment substrate surface side, and the progress of the polymerization is delayed at the side in contact with oxygen. In the production method, oxygen inhibits the polymerization so that the rate of the polymerization can be varied in the thickness direction, and thus the cholesteric pitch length of the cholesteric liquid crystal layer can be varied.

In the polymerization of the liquid crystal mixture, oxygen, which becomes a radical trap during the application of ultraviolet irradiation, naturally diffuses from the coating surface side so that the concentration of the oxygen can vary in the thickness direction from the oxygen-supplying surface to the alignment substrate side. The rate of the polymerization can be varied depending on the concentration of the polymerization inhibitor, oxygen, so that the cholesteric pitch length can be varied in the thickness direction.

The conventional techniques as disclosed in Japanese Patent Application Laid-Open No. 06-281814 have many problems such as uneven thickness and an increase in the number of laminating steps caused by placement of a cover film for preventing oxidative damages, and the additional cost of the cover film. In contrast, the production method of the invention using the oxygen inhibition can be free from such problems.

Ultraviolet irradiation may be applied under any conditions. The combination or control of the ultraviolet irradiation conditions and the heating conditions allows the production of the independent selective reflection wavelength bands or modification of the distance between the central wavelengths of the selective reflection wavelength bands. In the process of exposure to ultraviolet irradiation, the environmental temperature may be raised in order to increase the mass-transfer speed.

In a case where a single step of applying ultraviolet irradiation is used for the polymerization, the temperature of the irradiation is at least 20° C., preferably from about 30 to about 150° C. In this case, the intensity of ultraviolet irradiation is preferably from about 20 to about 200 mW/cm², more preferably from 30 to 150 mW/cm². The ultraviolet irradiation time may be from about 20 to about 120 seconds, preferably from 25 to 60 seconds. If the intensity of Ultraviolet irradiation is less than 20 mW/cm², the polymerization in such a manner that a distribution of the monomer is formed in the thickness direction can fail to occur so that at least two independent selective reflection wavelength bands can fail to be produced. If the intensity of Ultraviolet irradiation is more than 150 mW/cm², the rate of the polymerization reaction can be higher than the rate of diffusion so that at least two independent selective reflection wavelength bands can fail to be produced.

Alternatively, the step of applying ultraviolet irradiation for polymerization and curing may include an earlier stage and a later stage which are controlled such that the temperature of the irradiation is higher at the later stage than at the earlier stage. The temperature of the irradiation at the earlier stage is preferably from about 20 to about 100° C., more preferably from 30 to 50° C. At this stage, the intensity of ultraviolet irradiation is preferably from about 10 to about 200 mW/cm², more preferably from 20 to 150 mW/cm², and the ultraviolet irradiation time may be from about 0.2 to about 7 seconds, preferably from 0.3 to 5 seconds. If the intensity of ultraviolet irradiation is less than 10 mW/cm², the polymerization in such a manner that a distribution of the monomer is formed in the thickness direction can fail to occur so that at least two independent selective reflection wavelength bands can fail to be produced. If the intensity of ultraviolet-irradiation is more than 200 mW/cm², the rate of the polymerization reaction can be higher than the rate of diffusion so that at least two independent selective reflection wavelength bands can fail to be produced.

Only heat treatment may be performed before the irradiation at the later stage. The heat treatment may be performed at a temperature of about 70 to about 100° C. The heating time is preferably at least 2 seconds, more preferably at least 10 seconds, generally from about 2 to about 120 seconds.

The temperature of the irradiation at the later stage is preferably from about 60 to about 140° C., more preferably from 80 to 120° C. Within the above ranges, the temperature difference between the earlier and later stages is preferably at least 10° C., more preferably at least 20° C. In such a case, the intensity of ultraviolet irradiation is preferably from about 1 to about 20 mW/cm², and the UV irradiation time may be from about 10 to about 120 seconds, preferably from 10 to 60 seconds. If the intensity of ultraviolet irradiation is less than 1 mW/cm², the polymerization in such a manner that a distribution of the monomer is formed in the thickness direction can fail to occur so that at least two independent selective reflection wavelength bands can fail to be produced. If the intensity of ultraviolet irradiation is more than 20 mW/cm², the rate of the polymerization reaction can be higher than the rate of diffusion so that at least two independent selective reflection wavelength bands can also fail to be produced.

In the environment during the ultraviolet irradiation, the liquid crystal mixture applied to the alignment substrate is in contact with an oxygen-containing gas. The oxygen-containing gas preferably contains at least 0.5% oxygen. Any environment capable of causing inhibition of the polymerization by oxygen may be used, and the irradiation may be performed under a usual air atmosphere. The oxygen concentration may be increased or decreased in view of the wavelength width for pitch control in the thickness direction and the velocity necessary for the polymerization.

After the cholesteric liquid crystal layer is formed, the polymerization may be completed by intense ultraviolet irradiation. Such ultraviolet irradiation is preferably performed in the absence of oxygen. Using such ultraviolet irradiation, curing can be achieved with no degradation of the cholesteric reflection bands, so that the pitch-varying structure can be fixed without being degraded. Ultraviolet irradiation may be applied from any of the alignment substrate side and the liquid crystal mixture coating side.

In the absence of oxygen, for example, an inert gas-atmosphere may be used. Any inert gas may be used, as long as it does not affect the ultraviolet polymerization of the liquid crystal mixture. Examples of such an inert gas include nitrogen, argon, helium, neon, xenon, and krypton. In particular, nitrogen is most widely used and preferred. Alternatively, a transparent substrate may be attached to the cholesteric liquid crystal layer to provide oxygen-absent conditions.

Any ultraviolet irradiation conditions under which the liquid crystal mixture can be cured may be used. In general, ultraviolet irradiation is preferably applied at a radiation intensity of about 40 to about 300 mW/cm² for about 1 to about 60 seconds. The irradiation temperature may be from about 20 to about 100° C.

The resulting cholesteric liquid crystal film may be used without being separated from the substrate or may be separated from the substrate before use.

The cholesteric liquid crystal film of the invention has at least two freely-selected independent selective reflection wavelength bands and has the function of reflecting/transmitting circularly polarized light in each of the selective reflection wavelength bands. The cholesteric liquid crystal film of the invention may be used as a circularly-polarized-light-reflecting film.

A laminate may be provided which comprises two layers of the circularly-polarized-light-reflecting films that have substantially the same selective reflection wavelength bands and are opposite in cholesteric twist direction. Such a laminate can function as a reflecting film only for wavelengths in the two freely-selected selective reflection wavelength bands.

A laminate similarly serving as a reflecting film may also be provided which comprises a laminate of two layers of the circularly polarized-light-reflecting films that have substantially the same selective reflection wavelength bands and are same in cholesteric twist direction; and a half-wave plate placed between the circularly-polarized-light-reflecting films.

While the half-wave plate may comprise any material, it is preferably produced with a general-purpose transparent resin film capable of having retardation by stretching, such as a polycarbonate film, a polyethylene terephthalate film, a polystyrene film, a polysulfone film, a polyvinyl alcohol film, and a poly methyl methacrylate film; a norbornene resin film such as an ARTON film manufactured by JSR Corporation; or the like. Biaxial stretching may also be performed. In such a case, a retardation plate capable of compensating variations in retardation value depending on the angle of incidence can be preferably used so that the view angle characteristics can be improved. Alternatively to the production of the retardation effect by stretching resins, for example, the half-wave plate may be produced by aligning a liquid crystal and fixing the resulting half-wave layer. Such a half-wave plate may also be used. Concerning the half-wave retardation, the front retardation value is preferably within the range of about λ/2±40 nm, more preferably of λ/2±15 nm, for light with a wavelength of 550 nm.

In such a cage, the thickness of the half-wave plate can be significantly reduced. For example, the retardation plate produced by the liquid crystal alignment has a thickness of several micrometers, while that produced by stretching has a thickness of several tens of micrometers.

In general, the thickness of the half-wave plate is preferably from 0.5 to 200 μm, particularly preferably from 1 to 100 μm.

Single-material, single-layer half-wave plates can work well for a specific wavelength but can sometimes have a degraded function for other wavelengths due to their wavelength dispersion characteristics. Thus, at least two types of different retardation plates each with a specified axis angle and a specified retardation may be laminated. The resulting laminate can be used as a broadband half-wave plate, which can work at a practically acceptable level in both of the two selective reflection wavelength bands. In this case, the respective retardation plates may be made of the same material, or the retardation plates may be produced with different materials respectively, by the same method as for the above half-wave plate and then combined. Such a broadband half-wave plate is particularly effective, if the space between the central wavelengths of the two selective reflection wavelength bands is large, specifically if the selective-reflection wavelength band exists in each of an ultraviolet wavelength range and an infrared wavelength range.

The cholesteric liquid crystal film (the circularly-polarized-light-reflecting film) may have the central wavelengths of the independent selective reflection wavelength bands in an ultraviolet wavelength range and an infrared wavelength range, respectively. The reflecting film comprising such a cholesteric liquid-crystal film is useful as an eye protecting film. The reflecting film bonded to a transparent supporting substrate can be used as an eye protecting plate. The substrate used for producing the cholesteric liquid crystal film may be used, as it is, as the transparent supporting substrate. Alternatively, any other similar substrate may be laminated to form the transparent supporting substrate.

Damages to the eyes from ultraviolet irradiation include damages to the cornea (snow blindness), cloudiness of the lens (cataract), and retinal damages (photoretinopathy). Such damages are not due to heat of light but due to photochemical reaction, and the degree of damages varies with the wavelength band of the light radiation and the irradiation time. It is known that in irradiation at short wavelengths within a visible range from blue to violet, additivity exists between the light exposure and the time, at a certain exposure dose that is from about one-millionsth to about ten-thousandth of the threshold for the thermal damages. That is described in detail in W. D. Gibbons and R. G. Alien: Invest Ophthalmol. Visual Sci., 19, p. 521 (1977) and D. H. Sliney: Ocular Radiation Hazards, Ch. 15 in Handbook of Optics III (2nd Ed.) pp. 15.1-15.16. Concerning infrared rays, damages to the cornea are generally known, which are described in detail in D. Sliney and M. Wolbarsht: Safety with Lasers and Other Optical Sources, Pienμm Pr. (1980).

The eye protecting film or the eye protecting plate may be applied to a variety of transparent viewing members. For example, that may be used as an eye-protecting optical filter for spectacles or glasses including sunglasses, protective glasses for laser working, and the like. That is also preferably used for window-glasses of vehicle's such as automobiles, windowpanes of buildings and the like.

A reflecting layer may be produced so as to cover two wavelengths within the visible light range. Such a reflecting layer can function as a complementary color type reflecting filter, which can provide higher light use efficiency and brighter display than a subtractive color filter or the like. The filter having such characteristics is preferably used as a color filter for liquid crystal displays.

### EXAMPLES

The invention is further described by means of the Examples and Comparative Examples below, which are not intended to limit the scope of the invention.

(Reflectance Spectrum and Width of Selective Reflection Wavelength Band)

The reflectance spectrum of the cholesteric liquid crystal film was measured with a spectrophotometer (Instantaneous Multisystem MCPD-2000 manufactured by Otsuka Electronics Co., Ltd.), and a wavelength band having at least half of the maximum reflectivity was defined as the width of the selective reflection wavelength band. The central wavelength for selective reflection is a value at the middle of the selective reflection wavelength band.

The other measuring instruments included a spectrophotometer U4100 manufactured by Hitachi, Ltd. which was used to measure spectral characteristics of transmission and reflection.

A front retardation value: (nx−ny)d and a thickness-direction retardation value: (nx−nz)d were calculated from the thickness d(nm) of the retardation layer and the refractive indexes nx, ny and nz at 550 nm, which were measured with an automatic birefringence analyzer (KOBRA-21ADH manufactured by Oji Scientific Instruments), wherein nx is a refractive index in the direction of X-axis where the in-plane refractive index was maximum, ny is a refractive index in the direction of Y-axis perpendicular to X-axis, and nz is a refractive index in the direction of Z-axis which was the direction of the thickness of the film. Retardations at oblique angles can be measured with the above automatic birefringence analyzer. The Nz coefficient is defined by the formula: Nz=(nx−nz)/(nx−ny).

The ultraviolet exposure equipment used was UVC-321 AMI manufactured by Ushio Inc.

### Example 1

In a solvent (cyclopentanone) were dissolved 94.9 parts by weight of a photo-polymerizable mesogen compound (1) (a polymerizable nematic liquid crystal monomer) and 5.1 parts by weight of a polymerizable chiral agent (LC756 manufactured by BASF Ltd.). To the resulting solution was added 0.5% by weight of a photopolymerization initiator (Irgacure 907 manufactured by Ciba Specialty Chemicals Inc.), based on the solids content of the solution, so that a coating liquid (with a solids content of 30% by weight) was prepared. The coating liquid was applied to a stretched polyethylene terephthalate film (an alignment substrate) with a wire bar so as to provide a post-drying coating thickness of 5 μm, and then the solvent was dried off at 100° C. for 2 minutes.

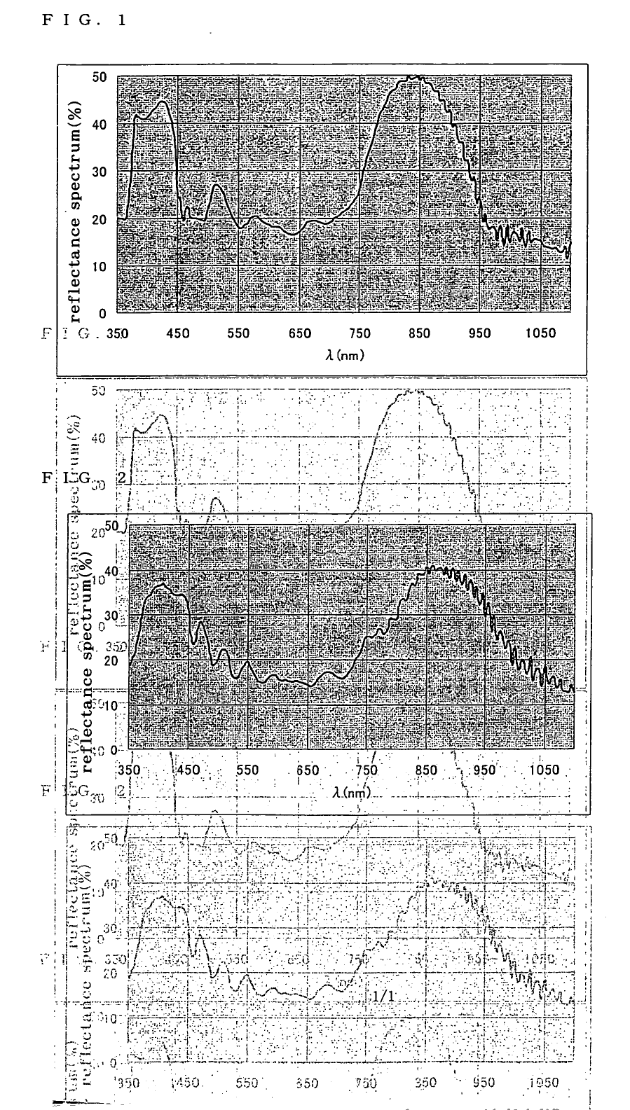

The resulting film was exposed to ultraviolet irradiation at 50 mW/cm² from the alignment substrate side at 85° C. under air atmosphere for 30 seconds so that a cholesteric liquid crystal film was obtained which had central wavelengths at 370 nm and 800 nm for selective reflection. Ultraviolet irradiation at 80 mW/cm² was then applied from the alignment substrate side under a nitrogen atmosphere for 30 seconds so that the polymerization was completed. During this ultraviolet irradiation, the central wavelengths for selective reflection were not changed. The reflectance spectrum of the resulting cholesteric liquid crystal film is shown in FIG. 1.

Using a transparent pressure-sensitive adhesive (No. 7 manufactured by Nitto Denko Corporation, 25 μm in thickness), the liquid ctystal side of the resulting cholesteric liquid crystal film was attached to each of both sides of a λ/2 plate (with a front retardation value of 270 nm), which was produced by uniaxially stretching a polycarbonate film, and then the alignment substrate was separated so that a two-wavelength-range reflection type reflecting film was obtained. The reflecting film had two selective reflection wavelength bands in which one central wavelength for selective reflection was 370 nm with a band width of 75 nm and the other central wavelength for selective reflection was 850 nm with a band width of 170 nm.

### Example 2

In a solvent (cyclopentanone) were dissolved 94.9 parts by weight of the photo-polymerizable mesogen compound (1) and 5.1 parts by weight of a polymerizable chiral agent (LC756 manufactured by BASF Ltd.). To the resulting solution was added 0.5% by weight of a photopolymerization initiator (Irgacure 907 manufactured by Ciba Specialty Chemicals Inc.), based on the solids content of the solution, so that a coating liquid (with a solids content of 30% by weight) was prepared. The coating liquid was applied to a stretched polyethylene terephthalate film (an alignment substrate) with a wire bar so as to provide a post-drying coating thickness of 5 μm, and then the solvent was dried off at 100° C. for 2 minutes.

The resulting film was subjected to first exposure to ultraviolet irradiation at 10 mW/cm² from the alignment substrate side at 40° C. under air atmosphere for one second. The film was then heated at 90° C. for one minute without ultraviolet irradiation. The film was then subjected to second exposure to ultraviolet irradiation at 5 mW/cm² from the alignment substrate side at 90° C. under air atmosphere for 60 seconds so that a cholesteric liquid crystal film was produced which had central wavelengths at 370 nm and 800 nm for selective reflection. Ultraviolet irradiation at 80 mW/cm² was then applied from the alignment substrate side under a nitrogen atmosphere for 30 seconds so that the polymerization was completed. During this ultraviolet irradiation, the central wavelengths for selective reflection were not changed. The reflectance spectrum of the resulting cholesteric liquid crystal film is shown in FIG. 2.

Using a transparent pressure-sensitive adhesive (Ad249 manufactured by TOKUSHIKI Co., Ltd., 5 μm in thickness), the liquid crystal side of the resulting cholesteric liquid crystal film was attached to each of both sides of an NRZ film manufactured by Nitto Denko Corporation (with a front retardation value of 270 nm and an Nz coefficient of 0.5), and then the alignment substrate was separated so that a two-wavelength-range reflection type reflecting film was obtained. The reflecting film had two selective reflection wavelength bands in which one central wavelength for selective reflection was 405 nm with a band width of 75 nm and the other central wavelength for selective reflection was 880 nm with a band width of 150 nm.

### Comparative Example 1

In a solvent (cyclopentanone) were mixed and dissolved 93.5 parts by weight of the polymerizable mesogen compound (1) and 6.5 parts by weight of a polymerizable chiral agent (LC756 manufactured by BASF Ltd.) so as to provide a central wavelength of 370 nm for selective reflection. To the resulting solution was added 0.5% by weight of a photopolymerization initiator (Irgacure 907 manufactured by Ciba Specialty Chemicals Inc.), based on the solids content of the solution, so that a coating liquid (with a solids content of 30% by weight) was prepared.

In a solvent (cyclopentanone) were mixed and dissolved 96.5 parts by weight of the photo-polymerizable mesogen compound (1) and 3.5 parts by weight of a polymerizable chiral agent (LC756 manufactured by BASF Ltd.) so as to provide a central wavelength of 800 nm for selective reflection. To the resulting solution was added 0.5% by weight of a photopolymerization initiator (Irgacure 907 manufactured by Ciba Specialty Chemicals Inc.), based on the solids content of the solution, so that a coating liquid (with a solids content of 30% by weight) was prepared.

The two types of the coating liquids were each independently applied to a stretched polyethylene terephthalate film (an alignment substrate) with a wire bar so as to each provide a post-drying coating thickness of 3 μm, and then the solvent was dried off at 100° C. for 2 minutes. The resulting films were exposed to ultraviolet irradiation at 47.5 mW/cm² from the cholesteric liquid crystal side at 40° C. under air atmosphere for 10 seconds so that a cholesteric liquid crystal film (A) with a central wavelength of 370 nm for selective reflection and a cholesteric liquid crystal film (B) with a central wavelength of 800 nm for selective reflection were produced, respectively. Ultraviolet irradiation at 80 mW/cm² was then applied from the cholesteric liquid crystal side under a nitrogen atmosphere for 30 seconds so that the polymerization was completed. During this UV irradiation, the central wavelengths for selective reflection were not changed.

The cholesteric liquid crystal films (A) and (B) were transferred and laminated with a transparent adhesive (Ad249 manufactured by TOKUSHIKI Co., Ltd., 5 μm in thickness) to form a broadband circularly-polarized-light-reflecting polarizer. The resulting reflective polarizer had central wavelengths at 370 nm and 800 nm for selective reflection.

The product was stacked on each of both sides of a retardation plate which was the same as used in Example 1 so that a two-wavelength-range reflection type reflecting film was obtained. The thickness of the resulting film was equal to that in Example 1. In this Comparative Example, however, the number of lamination processes was twice that in Example 1, and the productivity was lower than in Example 1. A reduction in yield also occurred due to foreign materials.

### INDUSTRIAL APPLICABILITY

The cholesteric liquid crystal film of the invention is useful as a circularly-polarized-light-reflecting plate (a circular polarization type reflective polarizer) and has two specific wavelength bands. If the two specific wavelength bands exist in an ultraviolet wavelength range and an infrared wavelength range, respectively, it will be useful as a film for eye protection. Such a film is preferably used for eyeglasses such as sunglasses and protective glasses for laser working, window-glasses of vehicles such as automobiles, and windowpanes of buildings. When the two specific wavelength bands exist in the visible wavelength range, it is preferably used as a complementary color type filter or the like for liquid crystal displays.

1. A cholesteric liquid crystal film, consisting of:
a single layer, which is a cholesteric liquid crystal film, formed by applying a liquid crystal mixture containing a polymerizable mesogen compound (A) and a polymerizable chiral agent (B) to an alignment substrate, and applying ultraviolet irradiation to the mixture, wherein
the cholesteric liquid crystal film has at least two independent selective reflection wavelength bands.

2. The cholesteric liquid crystal film according to claim 1, wherein the independent selective reflection wavelength bands have central wavelengths for selective reflection in an ultraviolet wavelength range and an infrared wavelength range, respectively.

3. The cholesteric liquid crystal film according to claim 1, wherein a reaction rate of the polymerizable mesogen compound (A) and the polymerizable chiral agent (B) is different, respectively.

4. The cholesteric liquid crystal film according to claim 1, wherein the number of polymerizable functional groups in the polymerizable chiral agent (B) is larger than those in the polymerizable mesogen compound (A).

5. A method of producing the cholesteric liquid crystal film according to claim 1, comprising the steps of:
applying a liquid crystal mixture containing (A) a polymerizable mesogen compound and (B) a polymerizable chiral agent to an alignment substrate; and
applying ultraviolet irradiation to the liquid crystal mixture from the alignment substrate side in such a state that the mixture is in contact with an oxygen-containing gas to polymerize and cure the mixture.

6. The method according to claim 5, wherein the step of applying ultraviolet irradiation to polymerize and cure the mixture is performed at a temperature of 20° C. or more.

7. The method according to claim 5, wherein, an ultraviolet irradiation temperature at a later stage in the step of applying ultraviolet irradiation to polymerize and cure is controlled higher than that at an earlier stage.

8. A two-wavelength-range reflection type circularly-polarized-light-reflecting film, comprising the cholesteric liquid crystal film according to claim 1.

9. A reflecting film capable of covering two wavelength ranges, comprising:
a laminate of two pieces of the circularly-polarized-light-reflecting film according to claim 8, wherein the two pieces of the circularly-polarized-light-reflecting film have substantially the same selective reflection wavelength bands and are opposite in cholesteric twist direction.

10. A reflecting film capable of covering two wavelength-ranges, comprising:
a laminate of a half-wave plate sandwiched between two pieces of the circularly-polarized-light-reflecting film according to claim 8, wherein the two pieces of the circularly-polarized-light-reflecting film have substantially the same selective reflection wavelength bands and are same in cholesteric twist direction.

11. The reflecting film according to claim 10, the half-wave plate is a broadband half-wave plate comprising a laminate of at least two different retardation plates.

12. An eye protecting film, comprising the reflecting film capable of covering two wavelength-ranges according to claim 9.

13. An eye protecting plate, comprising:
a transparent supporting substrate; and
the eye protecting film according to claim 12 which is bonded to the substrate.

14. A transparent viewing member, comprising the eye protecting film according to claim 12.

15. A complementary color filter, comprising the reflecting film according to claim 8.

16. A liquid crystal display, comprising the complementary color filter according to claim 15.

17. A transparent viewing member, comprising the eye protecting plate according to claim 13.
